(19) United States
(12) Patent Application Publication
(10) Pub. No.: US 2021/0186002 A1
(43) Pub. Date: Jun. 24, 2021

(54) HUNTING BLIND

(71) Applicant: AOB Products Company, Columbia, MO (US)

(72) Inventors: Ryan Varnum, Columbia, MO (US); Timothy S. Kinney, Warrenton, MO (US); Seth Wheeler, Columbia, MO (US); James Tayon, Moberly, MO (US); Jason Nickerson, Columbia, MO (US); Kyle Smith, Columbia, MO (US); Matthew Kinamore, Columbia, MO (US); Curtis Smith, Columbia, MO (US)

(21) Appl. No.: 17/129,872

(22) Filed: Dec. 21, 2020

Related U.S. Application Data
(60) Provisional application No. 62/950,696, filed on Dec. 19, 2019.

(51) Int. Cl. A01M 31/02

(52) U.S. Cl. CPC A01M 31/025

(57) ABSTRACT

A hunting blind, components thereof, and associated methods. The blind includes a window or door comprising a closure that when open defines an opening for seeing out of the blind and/or providing ingress and egress for an interior of the blind. The closure comprises first and second closure strips and a slider movable along the closure strips to open and close the opening. The first closure strip includes a first rib having a longitudinal axis extending along a length of the first closure strip. The second closure strip includes a first channel having a longitudinal axis extending lengthwise of the second closure strip.

### CROSS-REFERENCE TO RELATED APPLICATION

The present application claims priority to U.S. Provisional Patent App. No. 62/950,696, filed Dec. 19, 2019, which is hereby incorporated by reference in its entirety.

### FIELD

The present disclosure generally relates to hunting equipment, and more particularly to a blind in which a person can be housed to hide the person from game.

### BACKGROUND

Hunters commonly used enclosures referred to as blinds to hind themselves from game being hunted. Such blinds may be used for other purposes too. One type of blind comprises a frame and a fabric cover forming a tent-like enclosure. Blinds typically have zippered door openings, which can be noisy and undesirable for hunting.

### SUMMARY

In one aspect, a hunting blind comprises a housing adapted to define an interior sized and shaped to receive a person for hiding the person. The housing includes a selectively openable window or door including a closure that when open defines an opening. The closure comprises first and second closure strips having respective lengths and corresponding mating structure. The mating structure is arranged to mate the first closure strip with the second closure strip to close the opening. The mating structure of the first closure strip comprises a first rib having a longitudinal axis extending lengthwise of the first closure strip. The mating structure of the second closure strip comprises a first channel having a longitudinal axis extending lengthwise of the second closure strip, the first rib being receivable in the first channel to mate the first and second closure strips to close the closure. The closure includes a slider on the first and second closure strips. The slider is movable along the first and second closure strips in a first direction to mate the first and second closure strips by forcing the first rib into the first channel. The slider is movable along the first and second closure strips in a second direction opposite the first direction to separate the first rib from the first channel to open the closure to define the opening.

Other objects and features of the present disclosure will be in part apparent and in part pointed out herein.

### BRIEF DESCRIPTION OF THE DRAWINGS

FIG. 1 is a left perspective of a hunting blind of the present disclosure;

FIG. 2 is a right perspective of the hunting blind;

FIG. 3 is a front elevation of the hunting blind;

FIG. 4A is a rear perspective of the hunting blind having a door thereof shown in a closed configuration;

FIG. 4B is a view similar to FIG. 4A but showing the door in an open configuration;

FIG. 4C is a perspective of an interior of the blind showing a rear side of a front of the blind;

FIG. 5 is a fragmentary perspective of the hunting blind showing part of a rear door closure of the blind in an open configuration;

FIG. 6 is a section of the rear door closure in the closed configuration;

FIG. 7 is a section of a closure strip of the rear door closure;

FIG. 8 is a perspective of a portion of the closure strip;

FIG. 9 is a top perspective of a slider of the door closure and closure strips received therein separated from a remainder of the blind;

FIG. 10 is a bottom perspective of the slider and door closure strips;

FIG. 11 is a bottom perspective of the slider;

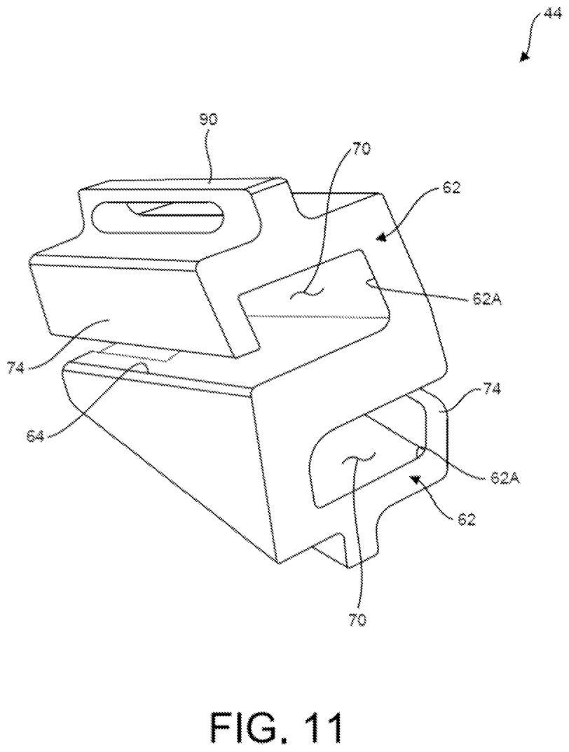

FIG. 12 is a top perspective of the slider;

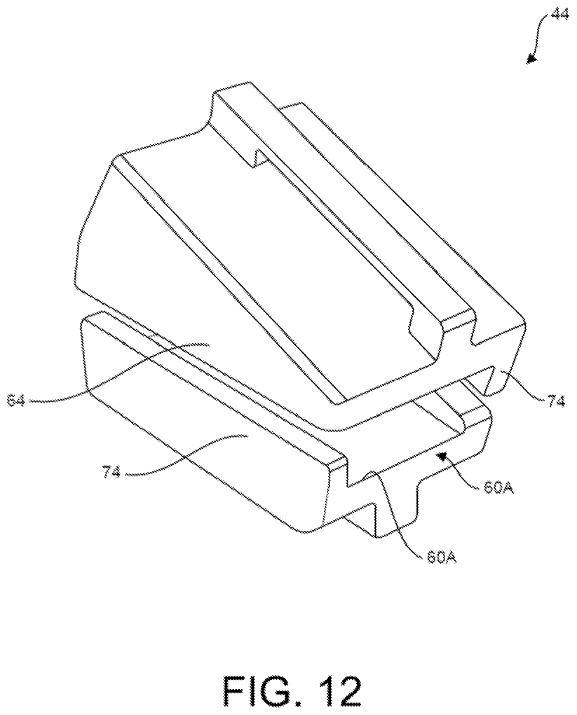

FIG. 13 is a top view of the slider;

FIG. 14 is a bottom view of the slider;

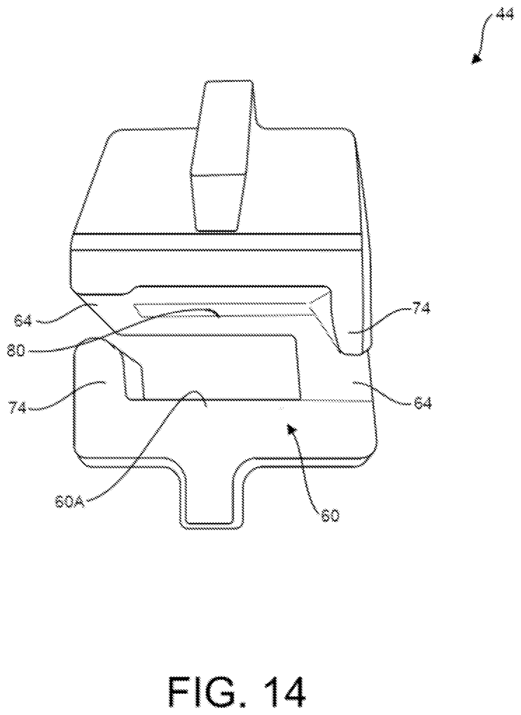

FIG. 15 is a right side view of the slider; and

FIG. 16 is a left side view of the slider.

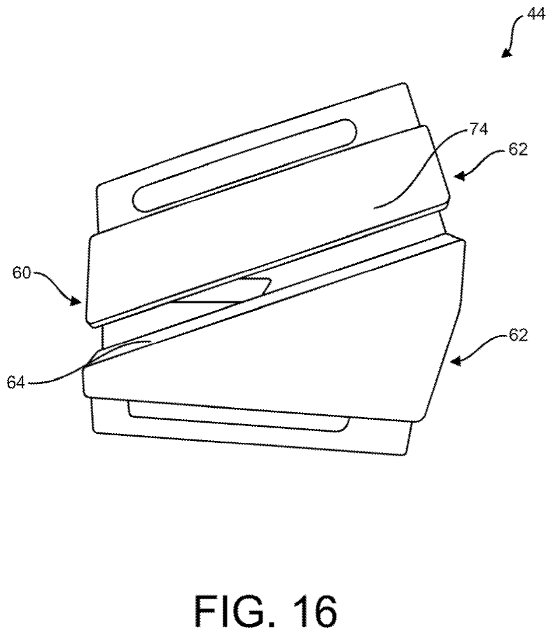

Corresponding reference numbers indicate corresponding parts throughout the drawings.

### DETAILED DESCRIPTION

A hunting blind of the present disclosure is generally indicated by 10. The hunting blind (broadly, “enclosure”) includes a frame 12 and a housing 14 supported by the frame. The housing 14 defines an interior in which a person or persons sit or stand to hide the person for hunting, photographing wildlife, or other purposes (e.g., shelter, sleeping). It will be appreciated that aspects of the present disclosure can be incorporated in other types of enclosures.

The frame 12 includes a plurality of supports 12A and connectors 12B (e.g., “hubs”) configured to support the housing 14 to define the interior. In the illustrated embodiment, the hunting blind 10 is designed to be portable. The frame 12 can be arranged in a compact stowed (e.g., collapsed) configuration and in an operational or deployed configuration to support the housing 14 to form the interior. In other embodiments, the frame can be less portable and/or non-collapsible.

The housing 14 includes a roof 16 and a plurality of side walls 20, 22, 24. In the illustrated embodiment, the housing 14 includes a front side wall 20, a left side wall 22, and a right side wall 24. The side walls 20, 22, 24 are arranged to provide the blind 10 with a generally triangular shape as viewed from above. Other shapes and/or other numbers of side walls can be used without departing from the scope of the present disclosure.

The housing 14 comprises a main body formed of fabric. The main body can comprise one or more pieces of fabric secured (e.g., sewn, adhered, fused, welded, etc.) together to form the main body. Other materials can be used together with or instead of the fabric without departing from the scope of the present disclosure. In one embodiment, the roof 16 and plurality of side walls 20, 22, 24 of the main body are formed of water-impermeable fabric, water-repellant fabric, and/or gas-impermeable fabric having a camouflage pattern. It will be appreciated that gas-impermeable fabric would better maintain scent of a person inside the blind to avoid spooking animals near or downwind of the blind.

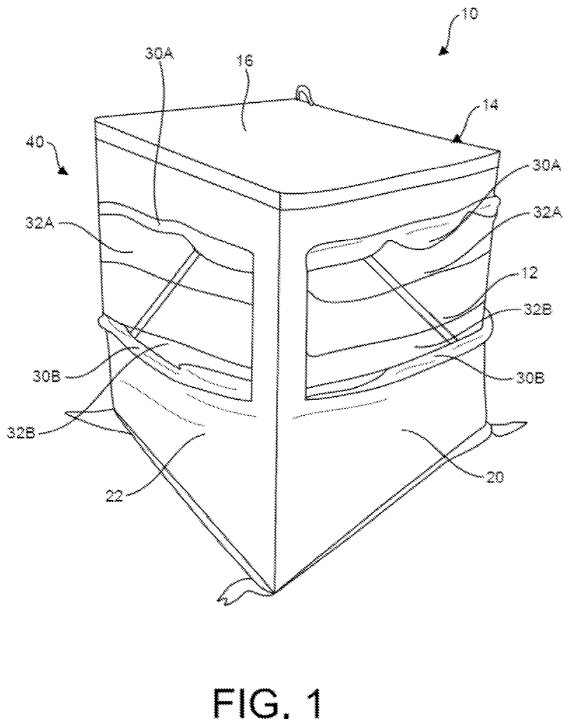

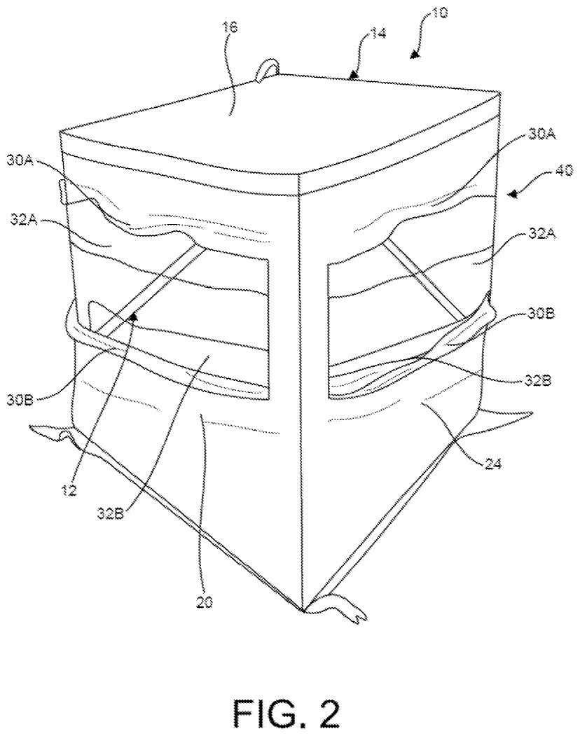

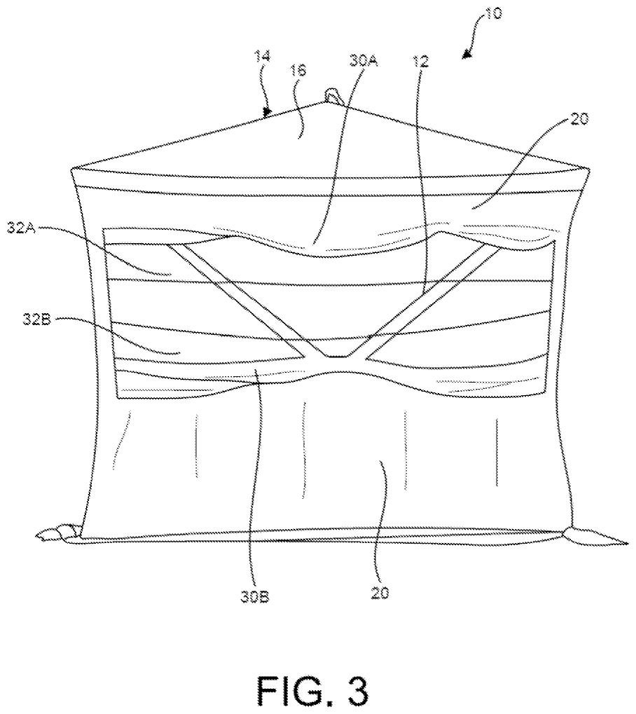

The housing 14 includes a plurality of windows and a door. Each of the side walls 20, 22, 24 includes a similar window. The windows can be opened and closed as desired to provide an improved view and/or permit firing of a weapon out of the blind, and the door permits ingress and egress. The windows comprise respective upper and lower window panels 30A, 30B and screen panels 32A, 32B all of which can be selectively opened and closed. The window panels 30A, 30B can be formed of fabric of the same type as the remainder of the housing 14. The screen panels 32A, 32B can be formed of material that permits greater visibility through the screen panels. The window panels 30A, 30B extend laterally across the window openings, overlap when closed, and can be opened by moving the upper panels 30A upward and the lower panels 30B downward to open the window opening therebetween, as shown in FIGS. 1-3. The window screen panels 32A, 32B are shown in a closed configuration in which upper panels overlap lower panels for closing the window opening with the screen panels. The window screen panels 32A, 32B can be opened in a similar fashion as the window panels 30A, 30B to provide unobstructed view or shooting out of the window openings. It will be appreciated that windows of the blind can include closures such as discussed below with respect to the door without departing from the scope of the present disclosure.

In the illustrated embodiment, the door is located at the rear of the blind 10. The door comprises portions of the left and right side walls 22, 24 (forming respective left and right door panels) and the meeting of the left and right side walls at a rear upstanding edge of the blind. In the illustrated embodiment, the blind 10 is taller at the rear corner of the blind (generally vertical or upstanding rear edge of the blind) than at the front right and left corners of the blind (generally vertical or upstanding front left and right edges of the blind). The door comprises a door closure 40 extending along the rear upstanding edge of the blind 10. The closure 40 includes first and second closure strips 42, and a slider 44 configured to join and separate the closure strips depending on whether the slider is moved upward or downward. The first closure strip 42 extends along an edge of the right door panel 24 and the second closure strip 42 extends along an edge of the left door panel 22.

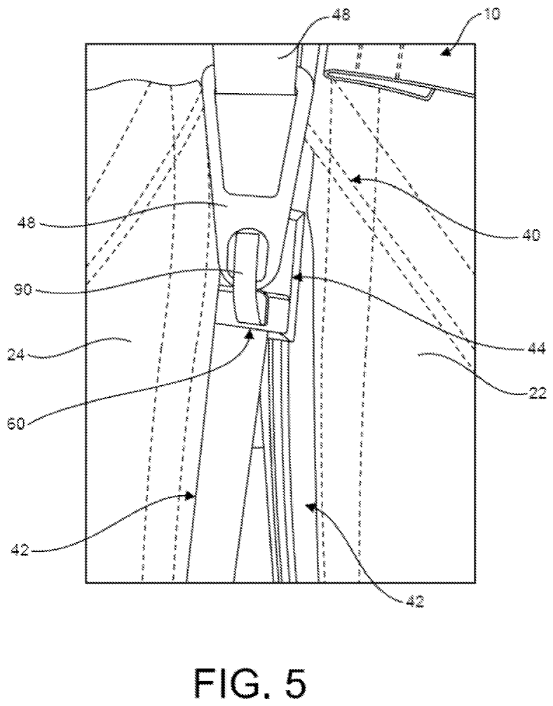

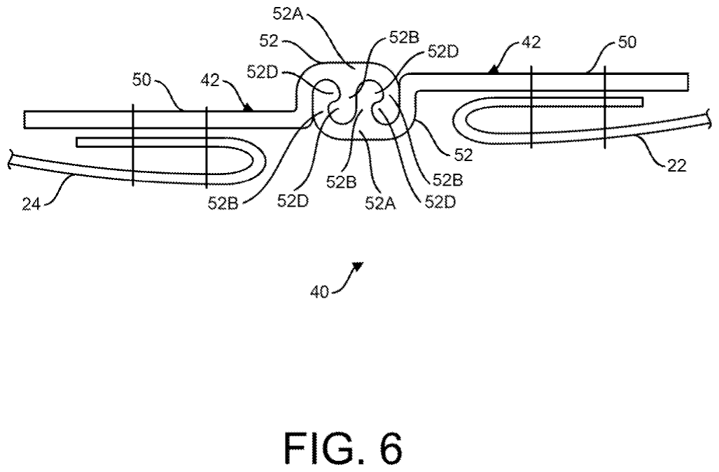

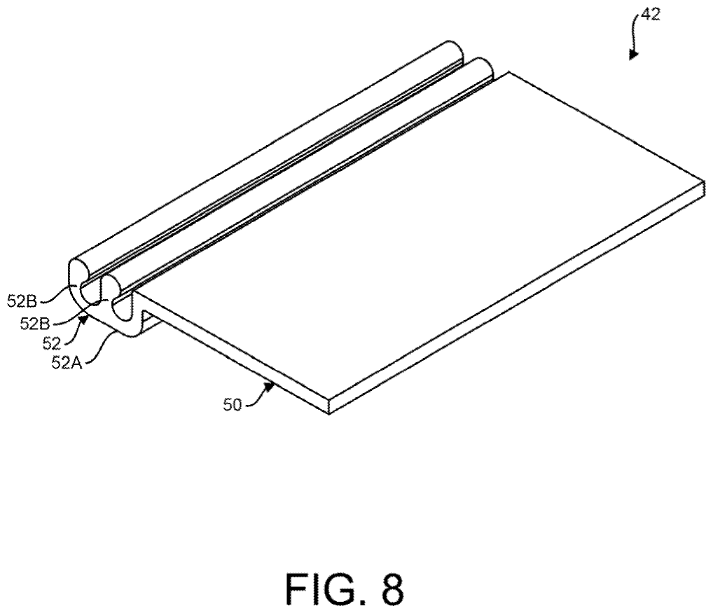

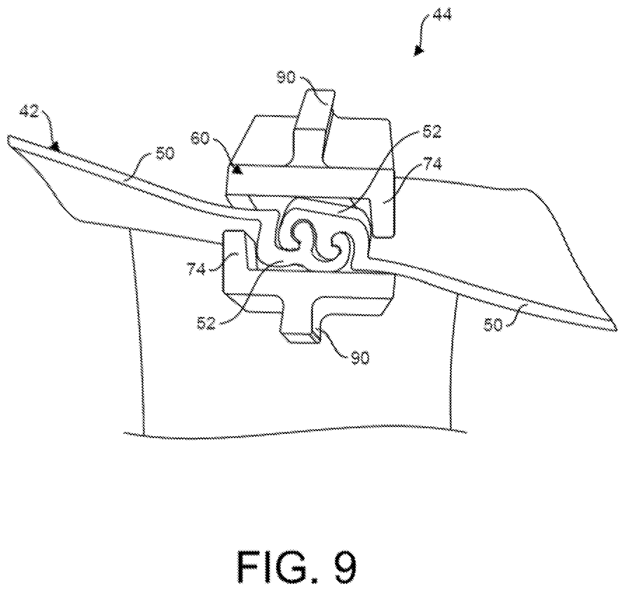

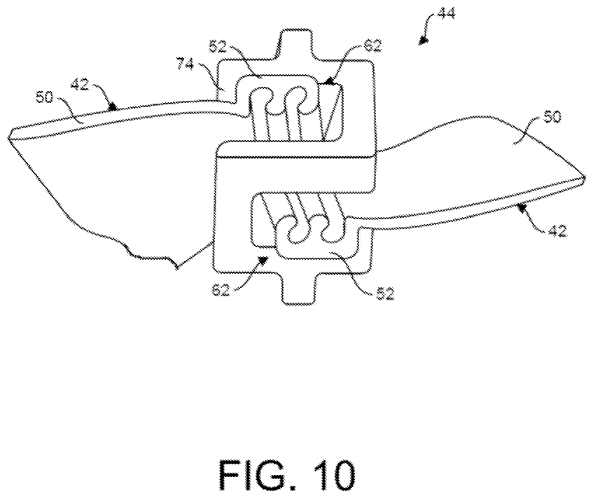

The closure 40 is shown in closer detail in FIGS. 5-10. The closure strips 42 have respective front (exterior) and rear (interior) faces. In FIG. 5, the front faces of the strips 42 face out of the page, and the rear faces face into the page. In FIG. 9, the front faces of the strips 42 face downward, and the rear faces face upward. On the other hand, in FIG. 10, the front faces of the strips 42 face upward, and the rear faces face downward.

The closure strips 42 can be formed to have the same construction as each other and mounted on the housing in opposite orientations such that the front face of one strip has the same construction of the rear face of the other strip. The closure strips 42 have lengths extending along the height of the blind. The closure strips 42 have thicknesses measured in a forward-to-rearward direction between surfaces of the front and rear faces. Desirably, the closure strips 42 are made of plastic (e.g., extruded plastic) or another suitable material (or combination of materials). In one embodiment (not shown), the connecting strip 50 is made of fabric and the mating strip 52 is made of plastic. Other configurations can be used without departing from the scope of the present disclosure.

Each closure strip 42 includes a connecting portion 50 and a mating portion 52. The connecting portion 50 is configured to be connected to the respective left or right door panel 22, 24. In the illustrated embodiment, the fabric of the left and right door panels 22, 24 is folded over and sewn by stitching 54 to the respective connecting portions 50. The connecting portions 50 can be connected to the panels 22, 24 in other ways (e.g., adhering, fusing, welding, fastening, etc.) without departing from the scope of the present disclosure.

The mating portions 52 include mating structure configured to mate to form a closure connection to close the door. In the illustrated embodiment, the mating portions 52 are mirror images of each other. When the mating portions 52 are mated, one of the mating portions overlaps the other mating portion (in a front-to-rear direction), and the connecting portions 50 extend laterally in opposite left and right directions away from the mated mating portions. Each mating portion 52 comprises a web 52A extending from the connecting portion 50 and two ribs 52B extending from the web. The web 52A includes a first segment extending transversely (forward/rearward) from the connecting strip 50 and a second segment offset from the connecting strip and extending from the first segment generally codirectionally (laterally) with the connecting strip. The arrangement is such that the mating portion 52 of a closure strip 42 is relatively thick (forward-to-rearward dimension) compared to the connecting portion 50.

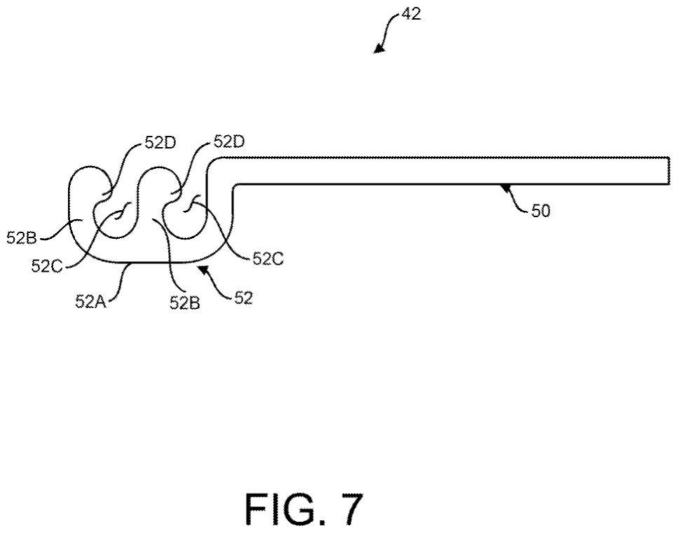

The ribs 52B and web 52A bound channels 52C. Flanges 52D (broadly, “keepers” or “retainers”) extend transversely with respect to the ribs 52B into the channels 52C (FIG. 7). The ribs 52B and flanges 52D in section define hooks configured for mating with hooks of the other mating strip 52 to maintain the closure connection. The ribs 52B and channels 52C have respective longitudinal axes extending lengthwise of the closure strips 42. The arrangement is such that the ribs 52B of each mating strip 52 are receivable in the channels 52C of the other mating strip, and the flanges 52D of the opposing mating strips engage each other in opposing retaining relationship to retain the ribs in the channels. The channels 52C are sized to make a generally tight conformance fit with the mated ribs 52B and flanges 52D. Desirably, but not necessarily, the webs 52A, ribs 52B, channels 52C, and/or flanges 52D are generally continuous along the length of the mating strips 52 such that when the mating strips are mated, the closure connection is continuous along its length and substantially water and/or gas impervious. Desirably, the ribs 52B and channels 52C are at least longer than the height of the slider (e.g., at least 1 inch long).

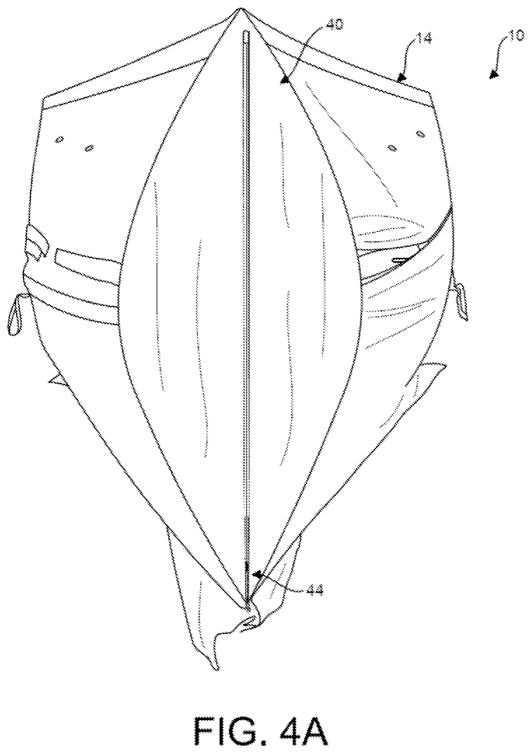

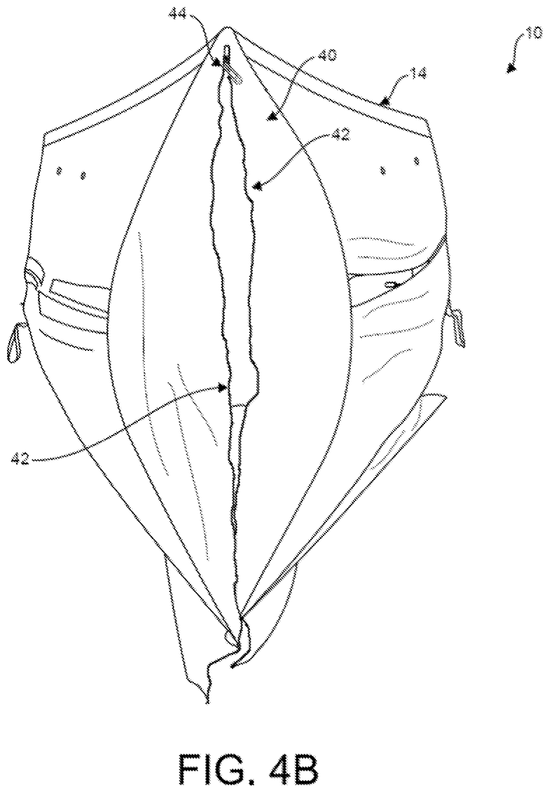

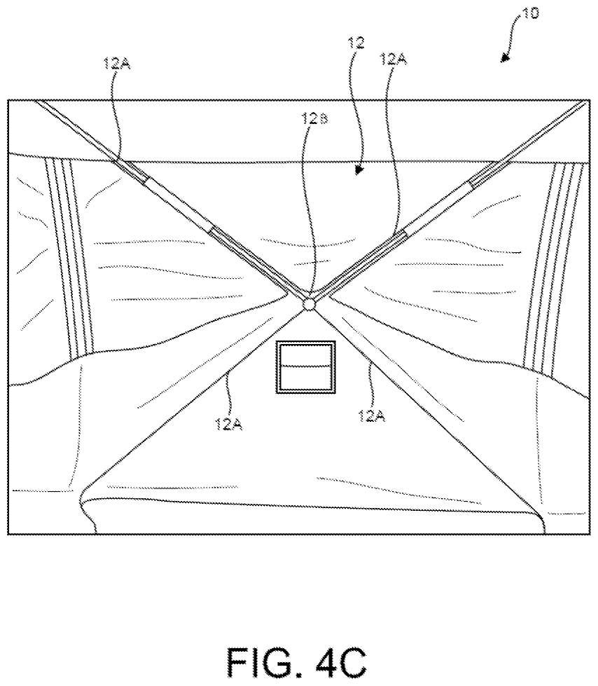

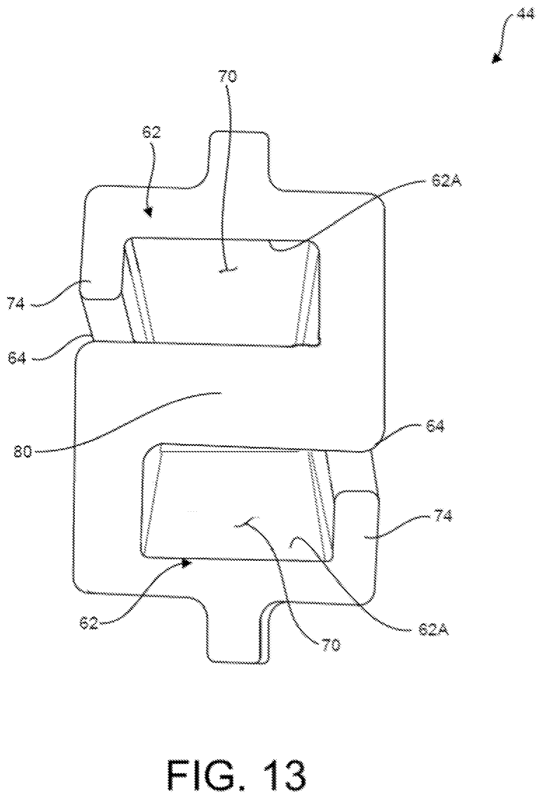

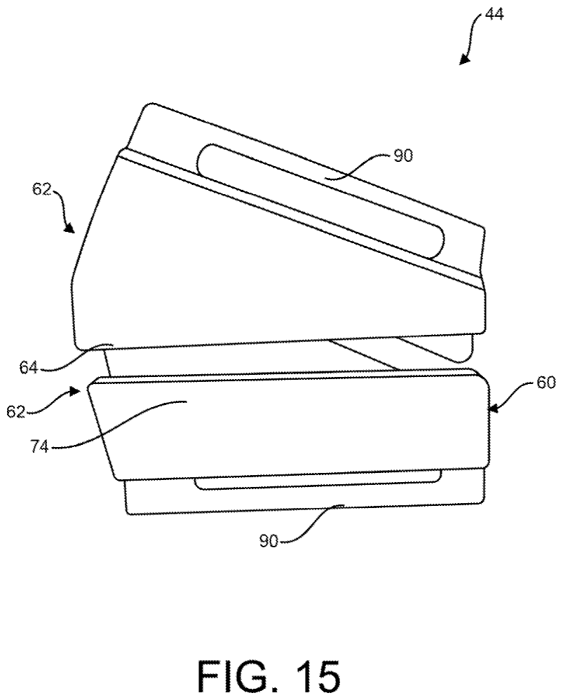

The slider 44 has a top end (facing upward in FIG. 5, out of the page in FIG. 9, and to the right in FIG. 15), a bottom end (facing downward in FIG. 5, out of the page in FIG. 10, and to the left in FIG. 15), opposite left and right sides (facing left and right, respectively, in FIGS. 5 and 10), a front face (facing outward in FIG. 5 and upward in FIG. 10), and a rear face (facing inward in FIG. 5 and downward in FIG. 10). The slider 44 includes an upper mouth 60 at the top end of the slider, and two lower mouths 62, at the bottom end of the slider. The mouths 60, 62 define openings 60A, 62A in the respective top and bottom ends of the slider 44 out of which the closure strips 42 extend. The slider 44 includes side openings 64 out of which the connecting portions 50 of the closure strips 42 extend from the slider. The left and right side openings 64 extend from the top opening 60A to respective ones of the bottom openings 62A. The mating portions 52 of the closure strips 42 are received in throats 70 (FIG. 13) of the slider extending upward from the bottom mouths 62. The throats 70 converge inside the slider 44 leading to the upper mouth 60 for the closure strips 42 to extend out of the upper mouth together. The slider 44 includes fences 74 extending from the top opening 60A to respective ones of the bottom openings 62A. The fences 74 cause the side openings 64 to be narrower (forward-rearward dimension) than the throats 70. As shown in FIG. 4, a first fence 74 extends forward, and the other fence 74 extends rearward, such that the intersection of the left side opening 64 with the top opening 60A is rearward with respect to the intersection of the right side opening 64 with the top opening. The mating portions 52 define tracks captured in the throats 70 of the slider 44. The arrangement is such that the mating portions 52 of the closure strands 42 are captured in the throats 70, with the fences 74 obstructing the mating portions from exiting laterally out of the left and right side openings 64. It will be appreciated that the directions referred to herein (e.g., top, bottom, left, right, front, rear, etc.) are for ease of reference in the description, and other arrangements can be used without departing from the scope of the present disclosure.

The slider 44 is movable in a first closing direction (e.g., downward) to close the closure and in a second opening direction (e.g., upward) opposite the closing direction to open the closure. As the slider 44 moves in the closing direction, the slider slides over the mating portions 52 of the closure strips 42, and the mating portions are forced together by the top mouth 60 such that the mating portions are mated. The slider 44 includes a separator 80 (e.g., wedge) below the top mouth 60 that separates the throats 70 below the top mouth. As the slider 44 slides in the opening direction, the separator 80 separates (e.g., wedges apart) the mating strips 52. During upward and downward movement of the slider 44, the fences 74 maintain the mating portions 52 in the throats 70 of the slider to prevent the closure strips 42 from inadvertently exiting the slider laterally.

The slider 44 includes pull connectors 90 and corresponding pulls 48 (e.g., fabric, metal, or rope tab and/or loop) pivotably connected to the slider for grasping by a user to pull the slider. The pull connectors 90 are provided on the front (outside) and rear (inside) faces of the slider.

It will be appreciated that other embodiments of closure strips can be used without departing from the present disclosure. A mating portion of a closure strip can include at least one of a rib, flange, and/or channel. Mating portions having various types of mating ribs and channels and/or retainers and keepers can be used. Desirably, but not necessarily, when the mating portions are mated, the formed closure connection is continuous and optionally substantially water and/or gas impervious. The closures of the present disclosure are believed to be quieter than toothed zipper closures and thus preferable for hunting or wildlife photography contexts in which animals can be spooked by noise.

Slide closures such as disclosed herein can be used to close openings other than door openings without departing from the scope of the present disclosure. For example, such closures can be provided along one or more peripheral edges of a window panel for closing a window opening with a window panel. Moreover, other types of door panels can have similar types of closures. The closure disclosed herein can be used for closing various types of openings (e.g., door openings, window openings). It will be understood the door disclosed herein can function as a window and can be referred to as a window or a door.

It will be apparent that modifications and variations are possible without departing from the scope of the invention defined in the appended claims.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A hunting blind comprising:
a housing adapted to define an interior sized and shaped to receive a person for hiding the person, the housing including a selectively openable window or door including a closure that when open defines an opening, the closure comprising:
first and second closure strips, the closure strips having respective lengths and corresponding mating structure arranged to mate the first closure strip with the second closure strip to close the opening, the mating structure of the first closure strip comprising a first rib having a longitudinal axis extending lengthwise of the first closure strip, the mating structure of the second closure strip comprising a first channel having a longitudinal axis extending lengthwise of the second closure strip, the first rib being receivable in the first channel to mate the first and second closure strips to close the closure;
a slider on the first and second closure strips, the slider being movable along the first and second closure strips in a first direction to mate the first and second closure strips by forcing the first rib into the first channel, and the slider being movable along the first and second closure strips in a second direction opposite the first direction to separate the first rib from the first channel to open the closure to define the opening.

2. A hunting blind as set forth in claim 1, wherein the first rib has a length of at least one inch extending along the length of the first closure strip and the at least one channel has a length of at least one inch extending lengthwise of the second closure strip.

3. A hunting blind as set forth in claim 1, wherein the mating structure of at least one of the first closure strip or the second closure strip comprises a second rib having a longitudinal axis extending lengthwise of said closure strip, and the mating structure of the other of the at least one of the first closure strip or the second closure strip comprises a second channel having a longitudinal axis extending lengthwise of said closure strip, the second rib being receivable in the second channel to mate the first and second closure strips to close the closure lengthwise of the first and second closure strips.

4. A hunting blind as set forth in claim 3, wherein the first closure strip comprises the second rib, and the second closure strip comprises the second channel.

5. A hunting blind as set forth in claim 3, wherein the second closure strip comprises the second rib, and the first closure strip comprises the second channel.

6. A hunting blind as set forth in claim 3, wherein the first rib has a length of at least one inch extending lengthwise of the first closure strip, and the second rib has a length of at least one inch extending generally parallel to the length of the first rib.

7. A hunting blind as set forth in claim 3, wherein the mating structure of at least one of the first closure strip or the second closure strip comprises a third rib having a longitudinal axis extending lengthwise of said closure strip, and the mating structure of the other of the at least one of the first closure strip or the second closure strip comprises a third channel having a longitudinal axis extending lengthwise of said closure strip, the third rib being receivable in the third channel to mate the first and second closure strips to close the closure lengthwise of the first and second closure strips.

8. A hunting blind as set forth in claim 7, wherein the first closure strip comprises the second rib and the third channel, and the second closure strip comprises the second channel and the third rib.

9. A hunting blind as set forth in claim 7, wherein the mating structure of at least one of the first closure strip or the second closure strip comprises a fourth rib having a longitudinal axis extending lengthwise of said closure strip, and the mating structure of the other of the at least one of the first closure strip or the second closure strip comprises a fourth channel having a longitudinal axis extending lengthwise of said closure strip, the fourth rib being receivable in the fourth channel to mate the first and second closure strips to close the closure lengthwise of the first and second closure strips.

10. A hunting blind as set forth in claim 9, wherein the first closure strip comprises the second rib, the third channel, and the fourth channel, and the second closure strip comprises the second channel, the third rib, and the fourth rib.

11. A hunting blind as set forth in claim 1, wherein the first and second closure strips have respective front and rear faces, the first rib facing forward on the front face of the first closure strip, and the first channel facing rearward on the rear face of the second closure strip.

12. A hunting blind as set forth in claim 1, wherein the slider has a first end, a second end opposite the first end, a first side, a second side opposite the first side, a front face, and a rear face opposite the front face, wherein the first end faces in the second direction, the second end faces in the first direction, and the slider has a length between the first and second ends shorter than a length of the first rib along the longitudinal axis of the first rib.

13. A hunting blind as set forth in claim 1, wherein the slider has a first end, a second end opposite the first end, a first side, a second side opposite the first side, a front face, and a rear face opposite the front face, wherein the slider is movable along the first and second closure strips in the first direction with the second end leading to mate the first and second closure strips by forcing the first rib into the first channel, and the slider is movable along the first and second closure strips in the second direction with the first end leading to separate the first rib from the first channel to open the closure to define the opening.

14. A hunting blind as set forth in claim 13, wherein the slide includes a first side opening on the first side and a second side opening on the second side, the first closure strip extending out of the first side opening, the second closure strip extending out of the second side opening, the first closure strip being captured by the slider to prevent the first closure strip from exiting the slider laterally out of the first side opening, and the second closure strip being captured by the slider to prevent the second closure strip from exiting the slider laterally out of the second side opening.

15. A hunting blind as set forth in claim 13, wherein the slider includes a first mouth at the second end, and the slider includes second and third mouths at the first end, the closure strips being received in the slider such that movement of the slider in the first direction causes the first and second closure strips to exit the first mouth mated to each other, and that movement of the slider in the second direction causes the first and second closure strips to exit the second and third mouths, respectively.

16. A hunting blind as set forth in claim 15, wherein the slider includes a first side opening extending along the first side of the slider from the first mouth to the second mouth, and the slider includes a second side opening extending along the second side of the slider from the first mouth to the third mouth, the first closure strip extending out of the slider through the first side opening.

17. A hunting blind as set forth in claim 16, wherein the first closure strip includes a first mating portion including the first rib, the first closure strip includes a connecting portion extending outside of the slider at the first side opening, the first mating portion having a greater thickness than the first connecting portion in a forward-to-rearward direction, wherein the second closure strip includes a second mating portion including the first channel, the second closure strip including a second connecting portion extending outside the slider at the second side opening, the second mating portion having a greater thickness than the second connecting portion in a forward-to-rearward direction, and wherein the slider includes a first throat in which the first mating portion is received and a second throat in which the second mating portion is received, the slider including a first fence obstructing the first mating portion from exiting laterally out of the first side opening, the slider including a second fence obstructing the second mating portion from exiting laterally out of the second side opening.

18. A hunting blind as set forth in claim 17, wherein the first fence protrudes rearward, and the second fence protrudes forward.

19. A hunting blind as set forth in claim 16, wherein the first side opening and second side opening intersect the first mouth, and the first side opening intersects the first mouth at a location forward of where the second side opening intersects the first mouth.

20. A hunting blind as set forth in claim 1, wherein the first rib extends continuously along the full length of the first closure strip, and the first channel extends continuously along the full length of the second closure strip.
